(19) United States
(12) Patent Application Publication
(10) Pub. No.: US 2017/0343688 A1
(43) Pub. Date: Nov. 30, 2017

(54) MECHANISM AND METHOD FOR REDUCED AIR CONSUMPTION IN A MARINE VIBRATORY SOURCE ELEMENT

(71) Applicant: CGG SERVICES SAS, Massy Cedex (FR)

(72) Inventors: John SALLAS, Plano, TX (US); Robert DOWLE, Massy (FR)

(21) Appl. No.: 15/322,187

(22) PCT Filed: Jul. 1, 2015
(86) PCT No.: PCT/IB2015/001345

§ 371 Date: Dec. 27, 2016

Related U.S. Application Data
(60) Provisional application No. 62/019,902, filed on Jul. 2, 2014.

(51) Int. Cl. G01V 1/137

(52) U.S. Cl. CPC G01V 1/137

(57) ABSTRACT

A method and source element for generating seismic waves in water. The source element includes a housing having an opening; an acoustic piston closing the opening; an actuating mechanism located inside the housing and configured to actuate the acoustic piston; and a decoupling mechanism interposed between the acoustic piston and the actuating mechanism. The decoupling mechanism allows the acoustic piston to move substantially independent of the actuating mechanism for a first frequency range.

### BACKGROUND

### Technical Field

Embodiments of the subject matter disclosed herein generally relate to methods and systems for generating seismic waves and, more particularly, to mechanisms and techniques for reducing an airflow requirement for maintaining a hydrostatic balance in a marine seismic source element.

### Discussion of the Background

Reflection seismology is a method of geophysical exploration to determine the properties of a portion of the earth's subsurface, information that is especially helpful in the oil and gas industry. Marine reflection seismology is based on the use of a controlled source that sends energy waves into the earth. By measuring the time it takes for the reflections to come back to plural receivers, it is possible to estimate the depth and/or composition of the features causing such reflections. These features may be associated with subterranean hydrocarbon deposits.

For marine applications, sources are mainly impulsive (e.g., compressed air is suddenly allowed to expand). One of the most used sources is air guns which produce a high amount of acoustic energy over a short time. Such a source is towed either at the water surface or at a certain depth by a vessel. Acoustic waves from the air gun propagate in all directions. The emitted acoustic waves' typical frequency range is between 6 and 300 Hz. However, the frequency content of the impulsive sources is not fully controllable, and different sources are selected depending on a particular survey's needs. In addition, use of impulsive sources can pose certain safety and environmental concerns.

Thus, another class of sources that may be used is vibratory. Vibratory sources, including hydraulically-powered, electrically-powered or pneumatically-powered sources and those employing piezoelectric or magnetostrictive material, have been used in marine operations. A positive aspect of vibratory sources is that they can generate signals that include various frequency bands, commonly referred to as “frequency sweeps.” In other words, the frequency band of such sources may be better controlled, as compared to impulsive sources.

Source arrays (i.e., a plurality of vibratory source elements) are now used in marine seismic acquisition because they more efficiently generate acoustic energy. The source array can be towed at a single depth or at variable depths, as would be the case for a curved source array. Dual or multi-level arrays are also sometimes used to reduce the effect of spectral notches due to destructive interference with surface reflections.

A marine seismic acquisition system employing vibratory elements is now discussed with regard to FIG. 1, which shows a single-depth source array 110, including identical source elements 108, being towed behind a vessel 101. The generated seismic energy 112 emitted by the source array gets reflected by various interfaces 116 and 118 located under the water. The reflected energy 114 propagates upward toward streamer 105, which is also towed by vessel 101. FIG. 1 shows, for simplicity, only one streamer 105. However, vessel 101 may tow many more streamers. Each streamer 105 includes plural receivers 106, which typically are a hydrophone, or particle motion sensor, or particle rotation sensor or any sensor configured to detect seismic signals.

The source elements 108 may be suspended from a float 120 (or not) for maintaining a certain depth relative to the water surface 122. Currently, the existing source elements are towed at a depth of about 6 to 50 m. The greater the depth, the greater the hydrostatic pressure exerted by the ambient water on the source element. Because a typical source element has a moving piston that generates the seismic waves, and the moving piston is exposed to the hydrostatic pressure of the ambient water, air has to be pumped inside the source element for balancing the outside water pressure. The amount of air to be pumped, for example, from the towing vessel, may be considerable.

Thus, there is a need to reduce the air flow to the source element that helps maintain an equilibrium between the ambient pressure and the inside pressure of the source element.

### SUMMARY

According to one embodiment, there is a seismic source element for generating seismic waves in water. The source element includes a housing having an opening, an acoustic piston closing the opening, an actuating mechanism located inside the housing and configured to actuate the acoustic piston, and a decoupling mechanism interposed between the acoustic piston and the actuating mechanism. The decoupling mechanism allows the acoustic piston to move substantially independent of the actuating mechanism for a first frequency range.

According to another embodiment, there is a method for generating seismic waves in water. The method includes deploying to a certain depth in water a housing having an opening and an acoustic piston closing the opening, actuating an actuating mechanism located inside the housing to move the acoustic piston to generate the seismic waves, and allowing the acoustic piston to move substantially independent of the actuating mechanism for a first frequency range, by interposing a decoupling mechanism between the acoustic piston and the actuating mechanism.

According to still another embodiment, there is a source element for generating seismic waves in water. The source element includes an acoustic piston, an actuating mechanism configured to actuate the acoustic piston, and a decoupling mechanism interposed between the acoustic piston and the actuating mechanism. The decoupling mechanism allows the acoustic piston to move relative to a moving part of the actuating mechanism for a first frequency range.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a seismic acquisition system;

FIG. 2 illustrates a cross-section of a source element;

FIG. 3 illustrates a hydrostatic pressure disturbance spectral distribution;

FIG. 4 illustrates a hydrostatic pressure disturbance over time;

FIG. 5 illustrates an amount of high pressure air that is pumped to a source element for balancing the ambient pressure;

FIG. 6 illustrates a source element having a decoupling mechanism for reducing the air consumption required to balance the ambient pressure;

FIG. 7 is a schematic diagram of the decoupling mechanism;

FIG. 8 illustrates a theoretical model of the source element of FIG. 6;

FIG. 9 illustrates the force transfer functions for a source element with and without a decoupling mechanism;

FIG. 10 illustrates the acceleration transfer functions for a source element with and without a decoupling mechanism;

FIG. 11 illustrates the influence of various constraints of the source element on the acceleration of the acoustic piston;

FIG. 12 illustrates the influence of various values of a certain constraint on the acceleration of the acoustic piston;

FIG. 13 illustrates the same influence of the constraint from FIG. 12 in terms of percentages;

FIG. 14 illustrates another source element having a decoupling mechanism;

FIG. 15A illustrates still another source element having a different decoupling mechanism;

FIG. 15B illustrates a different mechanism for reducing air consumption;

FIG. 16 illustrates a method for generating seismic waves with a source element having a decoupling mechanism;

FIG. 17 illustrates a method for processing seismic data; and

FIG. 18 is a schematic diagram of a control device.

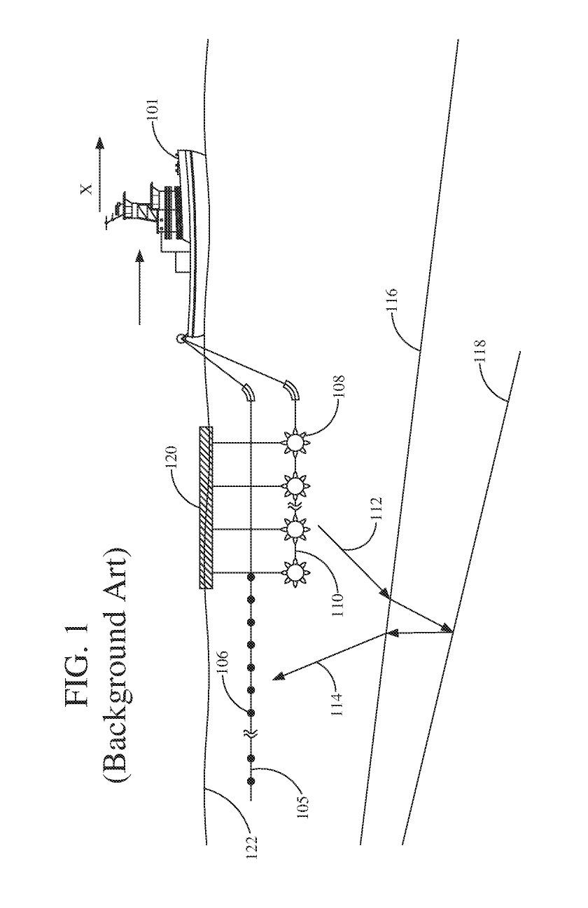

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a source element configured to generate acoustic energy in a marine environment. However, the embodiments to be discussed next are not limited to a marine source element; they may be applied to source arrays (i.e., to a collection of source elements) or even to land and transition zone sources.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a source element for generating seismic waves in water includes an acoustic piston, an actuating mechanism for actuating the acoustic piston, and a decoupling mechanism interposed between the acoustic piston and the actuating mechanism. The decoupling mechanism allows the acoustic piston to move relative to a moving part of the actuating mechanism for a first frequency range.

One example of a vibratory source element is described in U.S. Pat. No. 8,565,041 and U.S. Pat. No. 8,619,497, which are assigned to the same assignee as the present application, the entire contents of which is incorporated herein by reference.

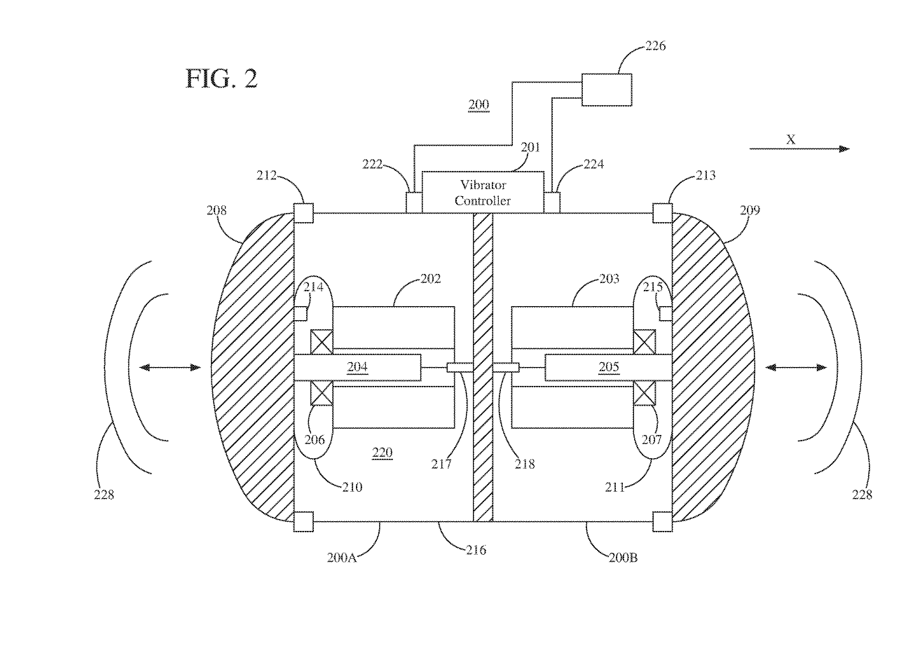

A cross-section of a vibratory source element 200 is illustrated in FIG. 2. Source element 200 is configured as a twin acoustic piston driver with two source halves 200A and 200B arranged in a back-to-back manner to reduce vibration of the entire source element. Source element 200 has a cabinet 216 having two openings, which are closed by two pistons 208 and 209. Since both pistons 208 and 209 are controlled by a vibrator controller 201, such that during a sweep both pistons move axially outward or inward in unison, resultant reaction forces on cabinet 216 are minimized. Cabinet 216, which houses most of the components of the source element, contains a volume of dry air 220, whose pressure is controlled by pneumatic controllers 222 and 224. Although FIG. 2 shows the pneumatic controllers 222 and 224 outside cabinet 216, in one embodiment, they are located inside the cabinet. Each of these controllers may include a servovalve. The servovalve serves to connect the cabinet's interior to a supply of high pressure gas 226 (e.g., a compressor that may be located on the towing vessel) and also to the ambient for venting out pressure if necessary. If the cabinet pressure is too low, the servovalve allows the high pressure gas to enter inside the cabinet. If the pressure is too high inside the cabinet relative to the ambient pressure, the servovalve vents the cabinet pressure outside the cabinet. In either case, the pneumatic controllers 222 and 224 regulate the cabinet's interior pressure so that it matches the ambient hydrostatic pressure seen, for example, on the wet side of pistons 208 and 209. In this regard, the “wet” part of the acoustic piston is considered to be the face facing the ambient and the “dry” part of the acoustic piston is considered to be the face facing the inside of the cabinet.

Pistons 208 and 209 are rigidly attached to moving magnets 204 and 205 respectively. When vibrator controller 201 directs current into actuator windings 202 and 203, a magnetic force acts on moving magnets 204 and 205 and accelerates them axially either inward or outward, depending upon the current polarity.

Because pistons 208 and 209 are rigidly coupled to magnets 204 and 205, they will move together with the moving magnets. Since pistons 208 and 209 are in direct contact with the surrounding water, when the pistons move with a given acceleration, they will generate an acoustic wave 228 that propagates through the water and into the earth. However, the moving magnets 204 and 205 have a limited range of travel along axis X. As the marine vibrator 200 is towed under water, the local ambient hydrostatic pressure P may vary due to the effect of swells or hydrodynamic forces.

Thus, if the pressure imbalance between the wet part and the dry part of pistons 208 and 209 is too great, pistons 208 and 209 may be either pushed inward or outward by the pressure imbalance. This results in magnets 204 and 205, which are rigidly attached to the pistons, to move near the end of their rated travel. As a consequence, if the moving magnet is near the end of travel, sweep drive levels need to be reduced to avoid the possibility of the linear actuator being driven outside its limits, which may result in unwanted nonlinear effects, premature failures or other problems.

A reduction in drive level means there will be a loss of generated acoustic source energy and/or the quality of the acquired data may suffer. Thus, to prevent these disadvantages, pneumatic controllers 222 and 224 need to operate continuously during the acquisition phase of acquiring data to keep the magnets operating around their center position. As will be shown later, this demand on the pneumatic controllers 222 and 224 leads to a high airflow, which is undesired and inefficient on the vessel.

FIG. 2 also shows bearings 206 and 207 that work to counter the buoyancy force due to the piston volume and the moment created by the hydrostatic pressure gradient across the face of the piston to keep the magnets centered, springs 210 and 211 that maintain proper alignment as well as zero-force centering. Pistons 208 and 209 are connected to cabinet (or enclosure or housing) 216 about their perimeter via circumferential sealing mechanisms 212 and 213, respectively. Sealing mechanisms may be formed of metal bellows or reinforced rubber or other flexible material that can ensure axial motion while at the same time preventing water ingress inside the cabinet. Cabinet 216 may also include displacement sensors 217 and 218 for determining the position of the pistons inside the cabinet, which can be used by the vibrator controller 201 to maintain the hydrostatic equilibrium. Accelerometers or other sensors 214 and 215 are located on pistons 208 and 209, respectively, to measure their movement (speed or position or acceleration or any combination of these quantities), which is also provided to the vibrator controller 201.

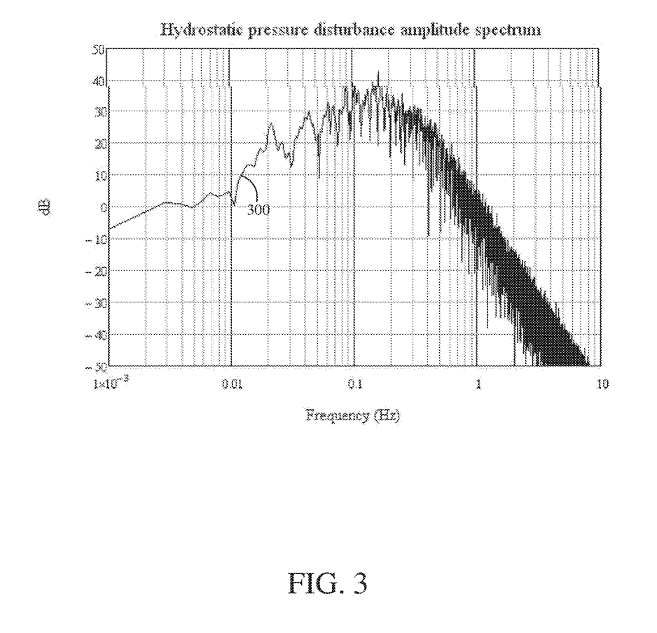

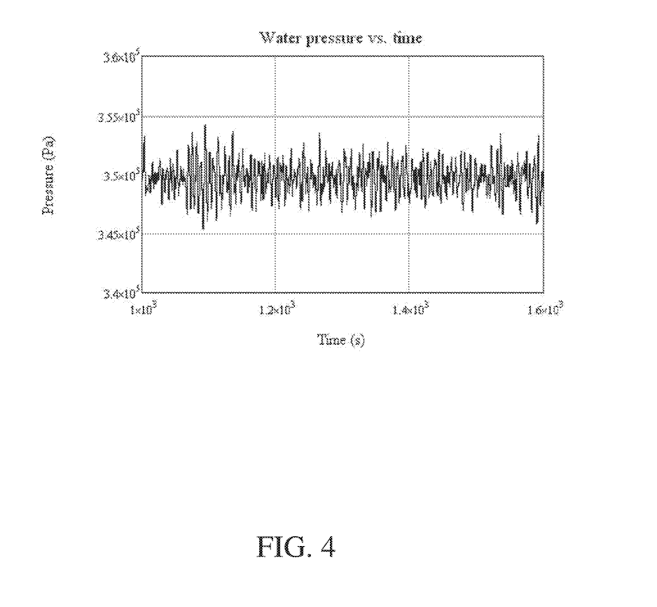

To appreciate the effect of hydrostatic pressure disturbance on a source element, FIG. 3 shows the energy spectral distribution for a hydrostatic pressure disturbance acting on a source element operating at 25 m depth. As can be seen, swell noise 300 is mostly a low-frequency effect, i.e., mostly below 1 Hz. The disturbance has a level of 100 mbar peak-to-peak, and an rms level of 13 mbar. A zoom of the pressure disturbance in the time domain is shown in FIG. 4 and this pressure disturbance is superimposed upon the 3.5 bar absolute pressure that is expected at a depth of 25 m due to the water weight.

Considering for the source element 200 that the piston area may typically be 0.6 m², a 100 mbar peak-to-peak pressure deviation would result in a disturbance force of as much as 6000 N peak-to-peak. This disturbance force acts on the wet side of pistons 208 and 209. When the source element 200 is operated at 25 m depth and the cabinet's interior is pressurized to 3.5 bar, if the cabinet's volume were sealed, the effective spring rate of the trapped air 220 volume would be about 500 N/mm. If the pneumatic controller 201 was inactive during operation at 25 m depth, this would result in unwanted piston travel of +/−5mm. If the actuator 202 was limited to +/−25 mm of travel, one can see that with the moving magnet 204 displaced by 5 mm from its center position due to pressure disturbance, the source element's piston 208 has only 20 mm of travel available in one direction. To avoid hitting stops located inside the cabinet, the drive level has to be reduced by 20%. This reduction is undesirable, since it implies an increase in dwell time of 40% to deliver the same acoustic energy. Thus, for this setup it is desired to have an active pneumatic control scheme (i.e., vibrator controller 201 should actively pump pressurized air in and out of the cabinet to counterbalance the pressure imbalance) in place to preserve the magnet centering.

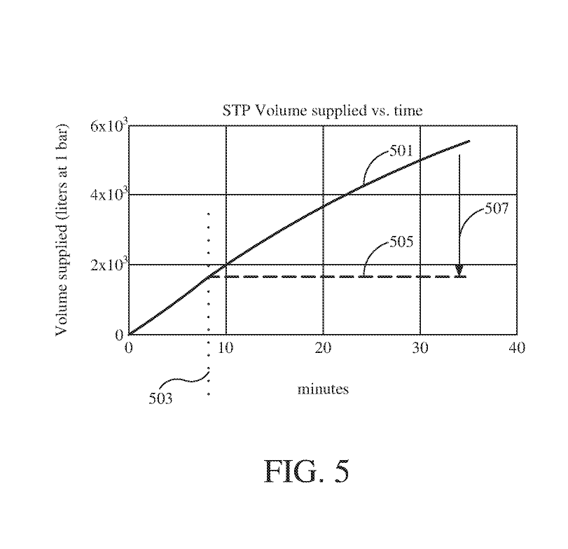

For such an active scheme, FIG. 5 shows the cumulative amount of gas delivered to a single source element towed at 25 m and operated for 20 minutes after reaching its operating depth, assuming a hydrostatic disturbance like that described above with regard to FIG. 3. For the following calculations, assume that the source element 200 is deployed at time 0 in water and then, it arrives to its operating depth of 25 m at time 503, which is about 8 minutes. During the time interval from zero to 503, about 1,800 liters of air need to be supplied to bring the cabinet pressure from 1 bar up to 3.5 bar. After time 503, the source element is actively sweeping and also it is exposed to the pressure disturbance noted in FIG. 3. Pneumatic controllers 222 and 224 continuously deliver or exhaust dry air from the cabinet to help keep the moving magnet centered.

Maintaining the hydrostatic balance consumes additional air, so at about 30 minutes (just 22 minutes of operating at depth 25 m), the source element has consumed 5,000 liters of air (corrected to 1 bar at 0° C.), an additional 3,200 liters of air more than what it took to just pressurize the cabinet for its operating depth. Line 501 illustrates the volume of air (on Y axis) supplied to the source element over time (X axis). Thus, it can be seen that a method that would reduce the amount of consumed air while accounting for pressure imbalances, so that the amount of used air changes from curve 501 to curve 505 is desirable, as a large amount of air 507 can be saved.

According to an embodiment, the amount of air flow necessary for maintaining the hydrostatic balance may be reduced if the pistons are allowed to partially move substantially independent of the corresponding magnets. In this context, moving “substantially independent” means that the piston can move for a given frequency range, e.g., below 5 Hz, or between 0 and 2 Hz, or any other range upper bounded by 10 Hz, relative to the moving magnet (or another moving part) of the actuating mechanism. However, as soon as the frequency is outside this range, the piston does not move independent of the actuating mechanism, i.e., the piston moves in unison with the moving part of the actuating mechanism. In other words, the piston does not move in unison with the moving part of the actuating mechanism for the given frequency range.

While FIG. 2 illustrated one possible source element that uses magnets for moving the pistons, those skilled in the art are aware of other source elements that use different actuating mechanisms for moving the pistons. Irrespective of the moving mechanism, the solution proposed herein is to partially disconnect or decouple (for a given frequency range only) the movement of the pistons from the movement of the actuating mechanism. This partial decoupling would allow the piston to move inward or outward to achieve a hydrostatic balance with reduced air consumption and, at the same time, does not disturb the actuating mechanism in achieving the hydrostatic balance.

However, the actuating mechanism still needs to act on the pistons, to move them back and forth for generating the seismic waves. Although the decoupling solution proposed herein appear to damage the rigid link between the piston and the actuating mechanism, which is needed for moving the piston, this is not so for the following reasons. The negative influence of hydrostatic imbalance has been observed at very low frequencies, e.g., less than 1 Hz. Thus, if the decoupling mechanism is ON at this frequency and below, e.g., between 0 and 1 Hz (this upper threshold frequency may have other values, for example, 2 Hz, 3 Hz or 5 Hz, depending on the characteristics of the vibrator), and it is turned OFF at frequencies about 1 Hz, the motion of the pistons will not be affected above 1 Hz as the link between the piston and the actuating mechanism would appear to be rigid above this frequency. Below the 1 Hz frequency, the motion of the piston may not exactly follow the motion imparted by the actuating mechanism (i.e., the motion of the piston is substantially independent of the motion of the magnet), but this distortion is likely to be small.

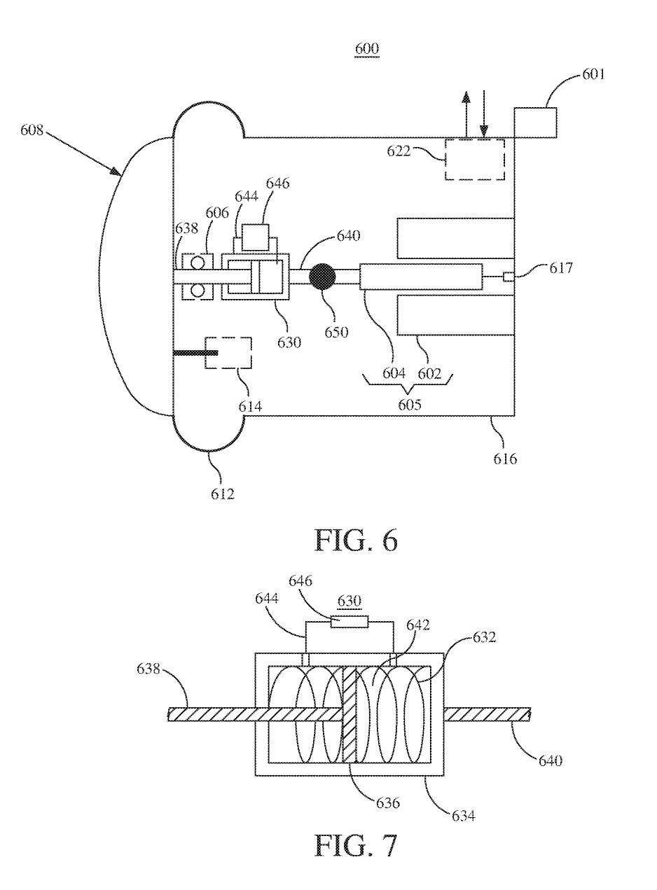

In one embodiment illustrated in FIG. 6, the decoupling mechanism is implemented as a dashpot. Those skilled in the art would know that other implementations of the decoupling mechanism may be imagined, e.g., and eddy current damper, an electrically controlled spring-like type device that acts as a dashpot at frequencies below a given frequency (e.g., 1 Hz) and acts as a rigid link at frequencies above the given frequencies.

FIG. 6 shows a cross-section of a single acoustic driver element 600, similar to one of the driver elements 200A or 200B shown in FIG. 2. The driver element 200A from FIG. 2 is used herein and modified to illustrate one implementation of a decoupling mechanism 630. In this figure, the actuating mechanism 605 includes a moving magnet 604 and a winding 602. However, as discussed above, other actuating mechanisms may be used. Those elements that are similar in the two figures have similar reference numbers and their description is now omitted.

FIG. 6 shows the acoustic piston 608 being coupled to the actuating mechanism 605 through decoupling mechanism 630, i.e. decoupling mechanism 630 is sandwiched between the acoustic piston 608 and actuating mechanism 605. In this embodiment, the decoupling mechanism 630 is a dashpot. Dashpot 630 is shown in more detail in FIG. 7. Dashpot 630 may or may not include a centering spring element 632. Centering spring element 632 is located inside dashpot housing 634, together with dashpot piston 636, but alternate locations are possible. Displacement transducer 614 is used to detect the piston's position relative to housing 616 and can be used as a feedback signal for the pneumatic controller should the piston approach the end of travel for seal 612. Dashpot piston 636 moves inside housing 634 for responding to hydrostatic imbalances. Centering spring element 632 may include two elements, on each side of dashpot piston 636. However, in one application, centering spring element 632 may include only one element, placed on either side of the dashpot piston. Dashpot piston 636 is rigidly connected to rod 638 that directly connects to acoustic piston 608. Another rod 640 connects to the housing 634. Inside housing 634, there may be a fluid 642, as will be discussed later. In one application, an alignment mechanism 650 may be inserted between rod 640 that is connected to decoupling mechanism 630 and actuating mechanism 605 for preventing misalignment of the corresponding rods. Alignment mechanism 650 may be, for example, a clamped ball-socket mechanism.

The net effect of the dashpot 630 is that the acoustic piston is substantially free to move, at a given frequency range, in and out to respond to hydrostatic pressure disturbances without engaging magnet 604. Ultimately, the limiting factor will be the range of travel allowed by seal 612 or the dashpot stroke, both of which are selected to have strokes greater than the actuator stroke. Thus, the acoustic piston can move inward/outward to increase/decrease the cabinet's volume and bring the internal and external pressures back to balance. Because as illustrated in FIG. 4, most of the hydrostatic disturbance is a low-frequency phenomenon, this disturbance force will be decoupled from the actuating mechanism 605 at low frequencies so that the moving magnet 604 will remain centered. At higher frequencies, the moving magnet forces will be transmitted to the acoustic piston and through the dashpot, since the viscous damping rate of the dashpot is selected so that it becomes stiff over the high-frequency range of interest.

Thus, as described in the embodiment of FIG. 6, the source element 600 is able to generate seismic waves in water, with a frequency range of about 0 to 200 Hz while minimizing the amount of air necessary to be used for eliminating or reducing pressure imbalances. The source element may include housing 616 having an opening, acoustic piston 608 closing the opening, actuating mechanism 605 located inside the housing 616 and configured to actuate the acoustic piston 608, and decoupling mechanism 630 interposed between the acoustic piston 608 and the actuating mechanism 605. The decoupling mechanism 630 allows the acoustic piston 608 to move substantially independent of the actuating mechanism 605 for a first frequency range. The decoupling mechanism 630 forces the acoustic piston 608 to move in unison with the actuating mechanism 605 for a second frequency range, different from the first frequency range. The first frequency range includes low-frequencies and the second frequency range includes high-frequencies in a range of zero to 200 Hz. In one application, the first frequency range is below 5 Hz and the high frequency range is above 10 Hz. In another application, the first frequency range is below 5 Hz and the high frequency range is above 5 Hz. In still another embodiment, the threshold value of 5 Hz is replaced with 1, 2 or 3 Hz.

A linear dashpot is typically a fluid filled cylinder, equipped with an internal piston that has a rod attached to it as illustrated in FIG. 7. There may be a leakage path 644 for fluid 642 between the housing 634's chambers. While FIG. 7 shows the leakage path 644 to be outside the housing, in one embodiment it may be inside the housing, either through a wall of the housing or directly through the dashpot piston 636. Fluid 642 is typically oil, either petroleum or silicone based. The dashpot creates an opposing force that is proportional to the relative velocity of the dashpot rod/piston to the dashpot housing. As the velocity is increased (frequency is increased), the dashpot becomes stiffer and stiffer. Equivalently, as the velocity is decreased (frequency is reduced), the dashpot becomes softer and does not transmit much force from the actuating mechanism to the acoustic piston at low frequencies.

One possible downside of using a dashpot coupling as in FIG. 7 is that the magnet may have to stroke a bit more to create the same acoustic piston acceleration as would be required by using a rigid coupling for some frequencies within the sweep bandwidth. However, it is possible to avoid this issue by including, for example, a mechanism to disable the dashpot in calm waters, which is discussed later in this application.

FIGS. 6 and 7 show that leakage path 644 may be controlled with a flow control mechanism 646, e.g., an adjustable valve. Flow control mechanism 646 may have a selectable orifice option, which controls the amount of fluid flowing between the two hydraulic cambers of the dashpot. Thus, rather than relying on an internal orifice (for example through dashpot piston 636) to provide a leakage path between the chambers of the housing 634, and thereby set the dashpot rate, the external path and associated flow control mechanism 646 may be used to set the rate of fluid flowing, i.e., the dashpot rate.

In one application, the flow control mechanism can be a poppet valve that either is open or closed. In another application, it can be a proportional valve that provides an adjustable orifice size to implement a variable dashpot rate. When the valve is closed, the dashpot rate becomes very high so that it acts like a rigid connection between the acoustic piston and the actuating mechanism. When the valve is open, that dashpot's rate is determined by the orifice flow area. Thus, for example, in calm waters the valve could be shut and in effect the dashpot feature disabled. In the presence of swells, when the hydrostatic pressure imbalance is likely to affect the source, the vibrator controller 601 that monitors, for example, winding's current, could be used to enable the dashpot by opening the valve. For this reason, the flow control mechanism is electrically connected, at least for data communication purposes, to the vibrator controller 601.

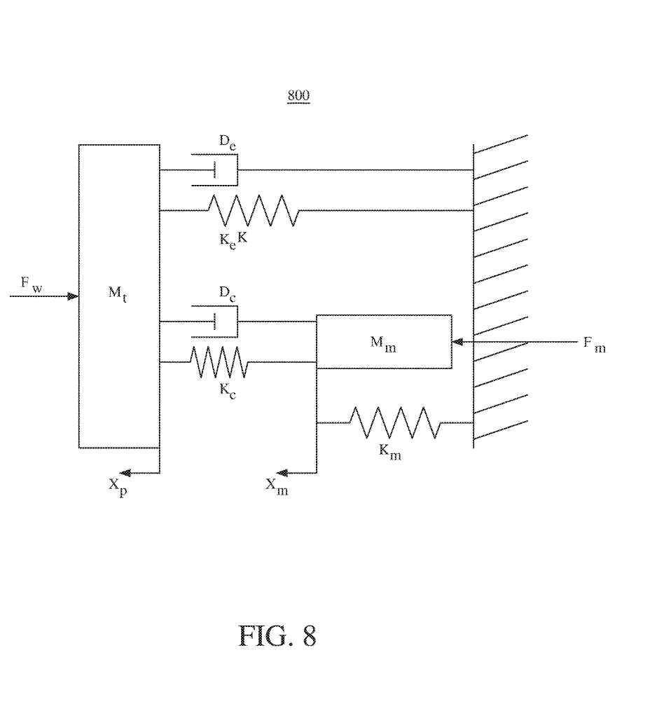

FIG. 8 shows a low-frequency lumped element model 800 for the driver element illustrated in FIG. 6. The describing state equations for this system are:

$$[ \begin{matrix}- {F}_{w} \\ {F}_{m}\end{matrix} ] = [ \begin{matrix}{M}_{t} {s}^{2} + ( {D}_{e} + {D}_{c} ) s + ( {K}_{e} + {K}_{c} ) & - ( {D}_{c} s + {K}_{c} ) \\ - ( {D}_{c} s + {K}_{c} ) & {M}_{m} {s}^{2} + {D}_{c} s + ( {K}_{c} + {K}_{m} )\end{matrix} ] [ \begin{matrix}{x}_{p} \\ {x}_{m}\end{matrix} ] \qquad ( 1 )$$

The variables in equation (1) are defined as follows:
xₚ is the piston's position relative to the piston center position (m);
xₘ is the magnet's position relative to the magnet center position (m);
F_{w} is the force acting on the piston due to hydrostatic pressure (N);
Fₘ is the force generated by the actuating mechanism (N);
Kₑ is the combined spring rate of the trapped enclosure air and the seal when at 25 m depth (500 kN/m);
Dₑ is the enclosure's viscous damping rate due to friction in bearings, radiation damping and other factors (2,500 N-s/m);
Kₘ is the spring rate of the actuating mechanism's suspension (22 kN/m);
Mₘ is the mass of the moving magnet and rigidly attached structure (12 kg);
Mₜ is the combined mass of piston, radiation mass and other driven structure (238 kg);
D_{c} is the damping rate of the dashpot connecting the piston to the actuating mechanism (N-s/m);
K_{c} is the spring rate of an optional spring that connects the piston to the actuating mechanism (N/m);
s is the Laplace operator and corresponds to a time derivative operation. For sinusoidal steady state it is equivalent to the Fourier jT, with j being imaginary one and T being the natural frequency.

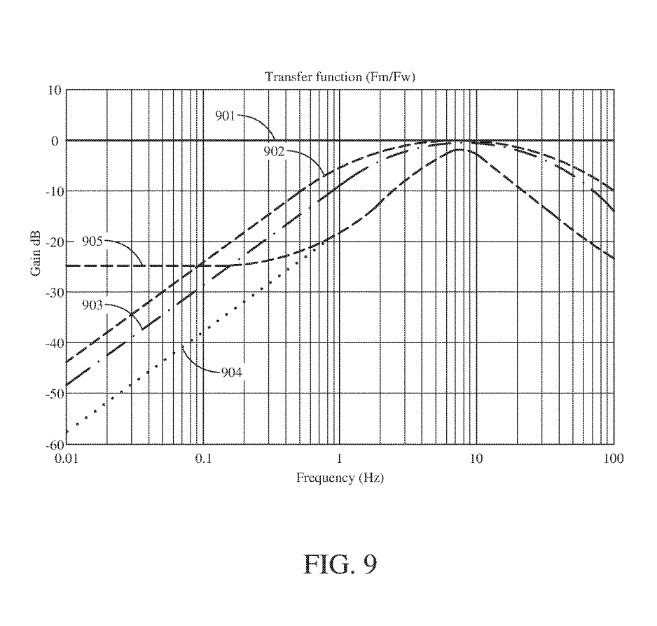

The solution of equation (1) may be evaluated for various dashpot viscous damping rates (D_{c}). For one case, for a non-zero spring rate (K_{c}), the solution (e.g., transfer function Fₘ/F_{w}) of equation (1) is illustrated in FIG. 9. The following cases are illustrated in FIG. 9: curve 901 indicates a solution for a rigid coupling between the actuating mechanism and the acoustic piston, curve 902 indicates the solution the dashpot having the damping constant D_{c}=50,000 N-s/m and K_{c}=0, curve 903 indicates the solution for the dashpot having the damping constant D_{c}=30,000 N-s/m and K_{c}=0, curve 904 indicates the solution for the dashpot having the damping constant D_{c}=10,000 N-s/m and K_{c}=0, and curve 905 indicates a solution for the dashpot having the damping constant D_{c}=1,000 N-s/m and K_{c}=30,000 N/m. FIG. 9 shows the amount of isolation between the hydrodynamic force applied to the wet side of the acoustic piston 608 and the transferred force acting on the moving magnet 604 for various frequencies.

For example, curve 901 shows that the coupling is rigid and all forces exerted to the wet side of the piston are transferred to the moving magnet, while curve 903 shows that for frequencies below 0.2 Hz a 22 dB reduction in the force transfer (or less that 8% of the force is transferred). In other words, if a hydrodynamic force of 5,000 N was to act on the piston face at 1 Hz, a force of only 400 N would be transferred to the moving magnet. Thus, there is substantially less force available to disturb the moving magnet to cause it to move away from its normal operating region with a decoupling mechanism as discussed above.

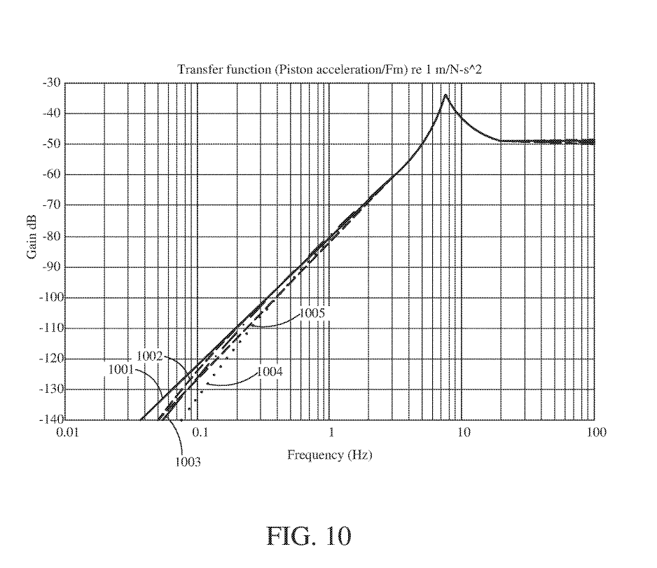

FIG. 10 shows the differences between the conventional configuration as shown in FIG. 2, which is represented by curve 1001 (i.e., rigid coupling) versus a source element equipped with a decoupling mechanism as shown in FIG. 6. The various dashpot cases are as described before, i.e., curve 100x in FIG. 10 corresponds to curve 90x in FIG. 9. FIG. 10 shows how much actuator force is being transferred from the actuating mechanism to generate acoustic piston's acceleration. Of particular interest is the operation over the typical sweep bandwidth for this kind of source at 4-30 Hz. It can be seen from FIG. 10 that for dashpot rates in the range of 3,000-10,000 N-s/m there is little degradation in performance and curves 1002 to 1005 follow closely the rigidly coupled piston curve 1001. Thus, performance of the source element is not degraded over the sweep frequency range for a suitable dashpot value as far as the transfer of force is concerned. However, there are other aspects to be considered. For example, the addition of the decoupling mechanism may increase the amount of travel required by the actuating mechanism to achieve the same force.

In the following embodiment, the impact of a decoupling mechanism coupled to the overall maximum output that can be achieved by the source element is investigated. There are several constraints that limit the overall output of an acoustic transducer like the one shown in FIG. 6, which uses an electro-dynamic actuator. These constraints include: a moving part's stroke (e.g., the range of allowed magnet travel for the embodiment illustrated in FIG. 6), maximum current rating, and maximum voltage for some frequencies.

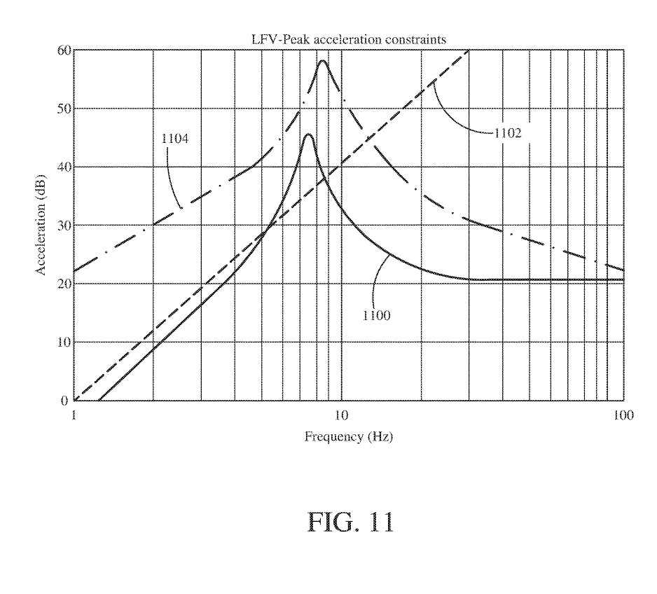

FIG. 11 illustrates the maximum acceleration that can be achieved due to these individual constraints for the embodiment illustrated in FIG. 6. In other words, curve 1100 illustrates the maximum acceleration versus frequency when only the current is considered to be the constraint, curve 1102 illustrates the maximum acceleration when only the displacement is considered to be the constraint, and curve 1104 illustrates the maximum acceleration when only the voltage is considered to be the constraint. The overall constraint for the entire operating frequency range will be the minima of the three curves 1100, 1102 and 1104. Those skilled in the art would understand that depending on the characteristics of the source element, more or less constraints may be considered. Also, there is no requirement to consider all the constraints. The operator of the source element may decide to select a subset of constraints to be considered. The curves in FIG. 11 assume the acoustic piston and magnet are rigidly attached to one another. Thus, for this example, below 5 Hz, the source element is constrained only by the current. Over the range of 5-9 Hz, the source element is limited by the magnet's stroke. From 9 to 33 Hz, the current again limits the output of the source element. Above 33 Hz, only the voltage is the limiting constraint.

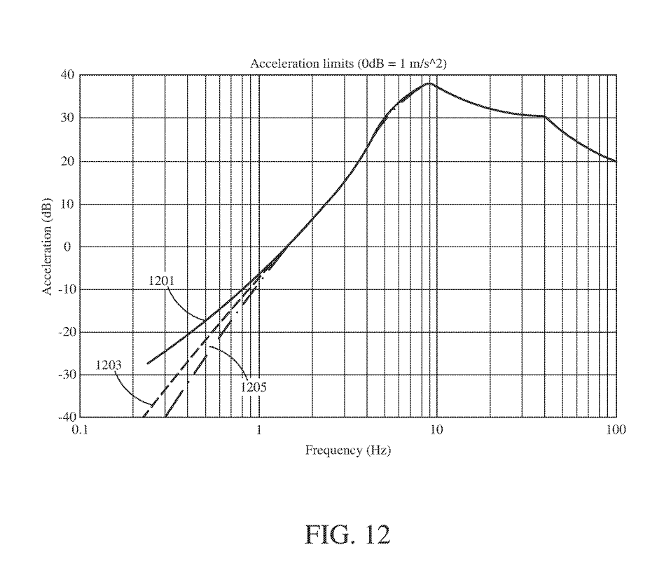

FIG. 12 shows the overall maximum possible acoustic piston's acceleration subject to current, stroke and voltage constraints, for several damping constants D_{c}. A seal limit and dashpot stroke limit are assumed to be greater than the actuator stroke limit and are not included in FIG. 12. Rigid coupling is described by curve 1201, curve 1203 describes dashpot coupling having D_{c}=50,000 N-s/m and curve 1205 describes a dashpot coupling having a D_{c}=30,000 N-s/m. It can be seen that the addition of the decoupling mechanism (dashpot in this case) severely impacts the achievable piston acceleration below 2 Hz in particular.

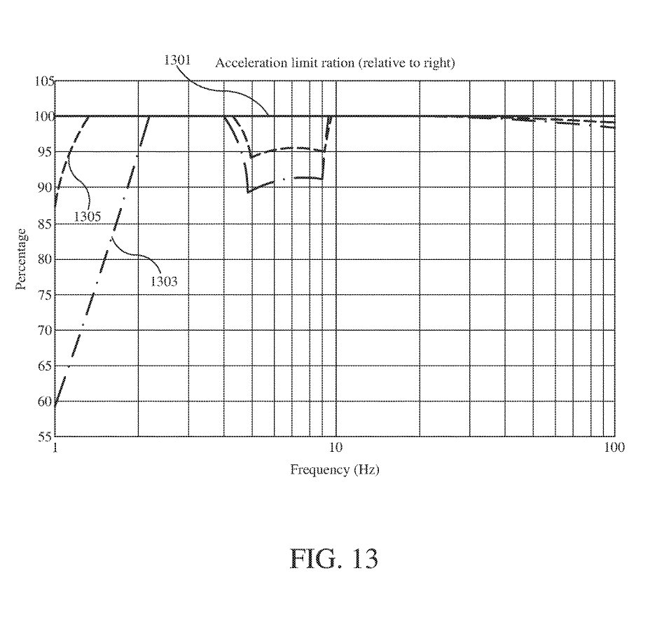

To better illustrate how much is lost over the sweep range of about 5-25 Hz, FIG. 13 plots the percentage of acceleration relative to the rigid coupling case. FIG. 13 shows the possible output for three cases, curve 1301 describes the rigid coupling, curve 1303 describes dashpot coupling having a damping of 50,000 N-s/m, and curve 1305 describes dashpot coupling having a damping of 30,000 N-s/m. The curves are calculated assuming no external pressure disturbance.

FIG. 13 shows that over the range of 5-9 Hz, the 50,000 N-s/m dashpot damping could potentially reduce the acceleration by about 5% while for the 30,000 N-s/m dashpot damping, it could reduce the acceleration by about 10% in quiet waters. This loss of output may not be significant when one realizes that an active pneumatic controller may not be able to keep the piston in the center of travel, i.e., even with a rigid coupling, a source element may not be able to drive the magnet from stop to stop in rough water anyway.

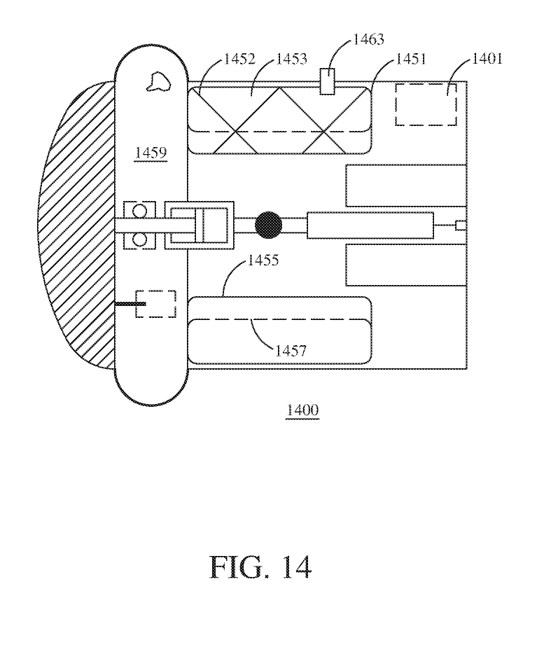

To further reduce the amount of air that needs to be supplied to pressurize the cabinet when first deployed underwater, the embodiment of FIG. 14 shows a source element 1400, which is similar to that shown in FIG. 6, but includes a reinforced elastic bladder 1451. The walls of the bladder 1451 can be made of an elastomer, for example, nitrile rubber that is reinforced with a material 1452 like Kevlar, to limit how much it can expand when its interior 1453 is filled with gas, for example dry air. Bladder 1451 is depicted as having a toroidal shape.

The mode of operation of bladder 1451 is as follows. Assume the source element is to be deployed at 25 m depth, where the hydrostatic pressure will be 3.5 bar absolute. Bladder 1451 before deployment is filled with gas through, for example, re-closeable inlet 1463 to a pressure smaller than the anticipated operating pressure at 25 m depth, for example, 3 bar absolute. Because at the surface the gas inside the cabinet interior 1459 is at atmospheric pressure (1 bar absolute), the walls of bladder 1451 will be stretched until the reinforcement material 1452 is under tension, so the bladder walls are extended to position 1455.

Instead of a Kevlar reinforcement, other means could be used, for example, a screen or other means to limit the amount the bladder can expand. Once deployed at the desired depth, pneumatic controller 1401 will supply pressurized air until cabinet's interior 1459 is at 3.5 bar absolute. When at the desired depth, because the cabinet's inside pressure is greater than the bladder's inflation pressure, the bladder will slightly relax and its walls will move to, for example, position 1457. Since the bladder has partially collapsed, the reinforcement material is no longer under tension and the bladder becomes compliant, so the gas inside the airbag is free to participate as part of the effective cabinet air-spring modeled as Kₑ in equation (1).

Thus, because the volume of air in the bladder takes up some of the cabinet's interior volume, less air would be required to pressurize the source element for operation at the desired depth. Because introduction of bladder 1001 takes up some space, its size may be limited as a practical matter.

In another embodiment, where the source is to be deployed at different depths, constrained bladder 1451 could be used to reduce the effective trapped air volume for an operation at a shallow depth. When the source element is deployed at greater depth, constrained bladder partially collapses and becomes an active part of the housing trapped air volume. By knowing the different operating depths, constrained bladder 1451's volume and charge pressure could be selected so that when the source element is operated at two different depths, it exhibits the same fundamental resonant frequency. In other words, the effective spring rate of the trapped air will be about the same at the two different depths with the change in volume offseting the change in hydrostatic pressure.

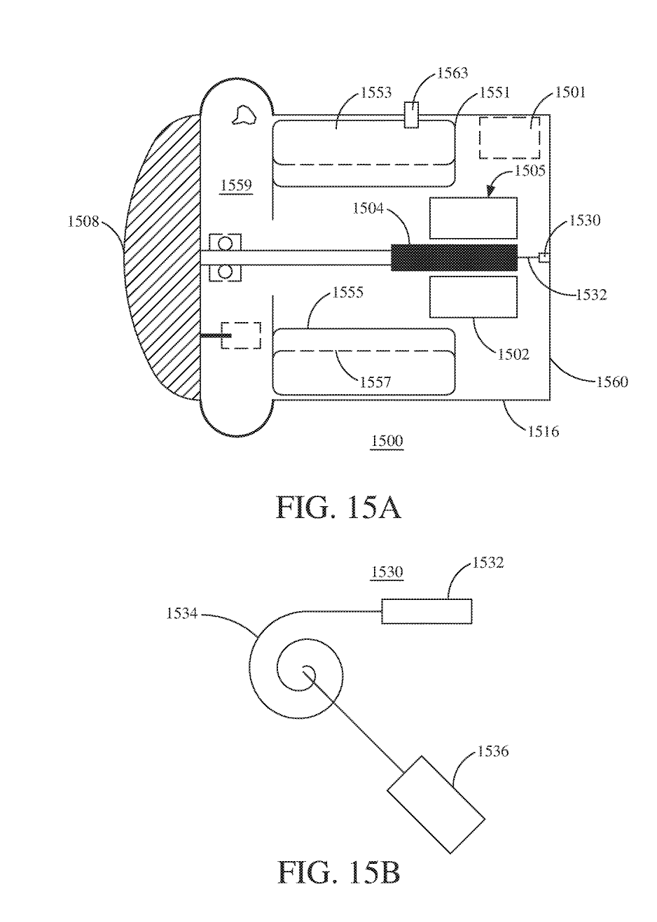

According to another embodiment illustrated in FIGS. 15A-B, instead of using a dashpot for the air consumption reducing mechanism as in the embodiment illustrated in FIG. 7, a spring mechanism is used. FIG. 15A shows a cross-section of a source element 1500 which is similar to that shown in FIG. 6, except the air consumption reducing mechanism 1530 does not include the dashpot. Mechanism 1530 is located inside housing 1516, either located on a back wall 1560 that separates the driver element shown in the figure from its twin driver element (not shown), or away from the walls of the housing by being supported by a corresponding support element (e.g., a strut, or brace, etc.). Mechanism 1530 is not sandwiched between acoustic piston 1508 and actuation mechanism 1505, as in the embodiments of FIGS. 6 and 14, but it is placed to sandwich the actuation mechanism between the acoustic piston and the decoupling mechanism as illustrated in FIG. 15A. A rod 1532 mechanically couples the mechanism 1530 to the actuating mechanism 1505. In one example, rod 1532 is coupled directly to the moving magnet 1504.

An implementation of the decoupling mechanism 1530 is illustrated in FIG. 15B and it includes a soft spring 1534. Soft spring 1534 may be a clock spring or torsional spring. A center of the soft spring 1534 may be attached to a motor 1536, which may be controlled to wind or unwind the clock spring for changing the force applied to the moving magnet 1504. Thus, a position of the moving magnet 1504 is adjusted, which translates in an adjusting of the acoustic piston's position. This adjustment may be coordinated with the pressure imbalance measured between the wet and dry faces of the acoustic piston, to compensate for fast pressure imbalances. For this embodiment, the vibrator controller simultaneously controls the actuating system 1505 and the rotating motor 1536. Rotating motor 1536 applies a low frequency force through spring 1534 to counter/offset any detected dynamic hydrostatic pressure force imbalance while at the same time the vibrator controller drives the actuating system 1505 with the sweep signal. In effect, the actuating system does not have to provide the force to overcome the swell noise, and with the soft spring, the actuating system is not unduly taxed as the piston oscillates. This embodiment is fast responding to pressure imbalances that quickly evolve in time. The air consumption reducing mechanism illustrated in this embodiment is configured to address pressure imbalances that vary in less than one minute.

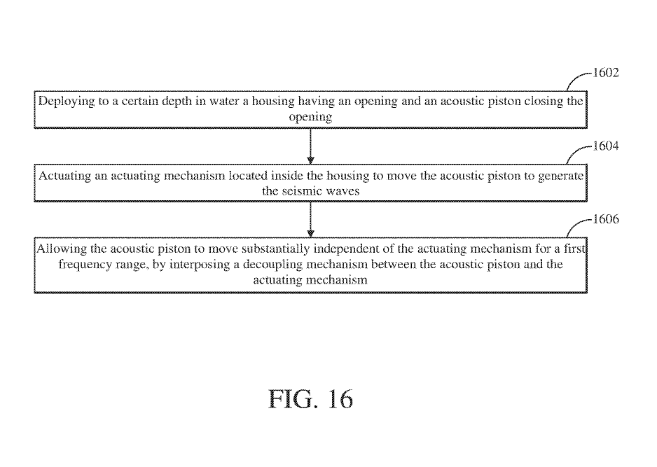

A method for generating seismic energy with a source element as described in one of the above embodiments is now discussed with regard to FIG. 16. The method includes a step 1602 of deploying to a certain depth in water a housing having an opening and an acoustic piston closing the opening, a step 1604 of actuating an actuating mechanism located inside the housing to move the acoustic piston to generate the seismic waves, and a step 1606 of allowing the acoustic piston to move substantially independent of the actuating mechanism for a first frequency range, by interposing a decoupling mechanism between the acoustic piston and the actuating mechanism. In an alternative embodiment, step 1606 is modified so that the piston is rigidly attached to the actuating mechanism and uses a second actuating mechanism that works in parallel with the first actuating mechanism providing only a force to counter the swell noise.

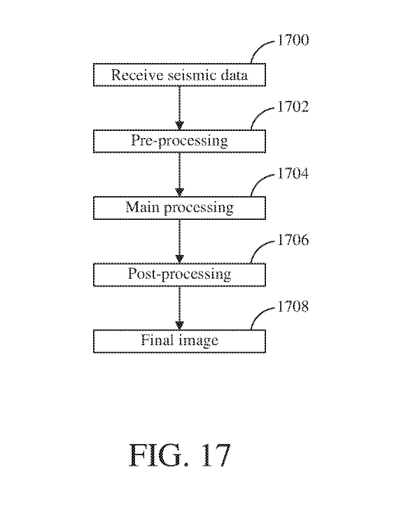

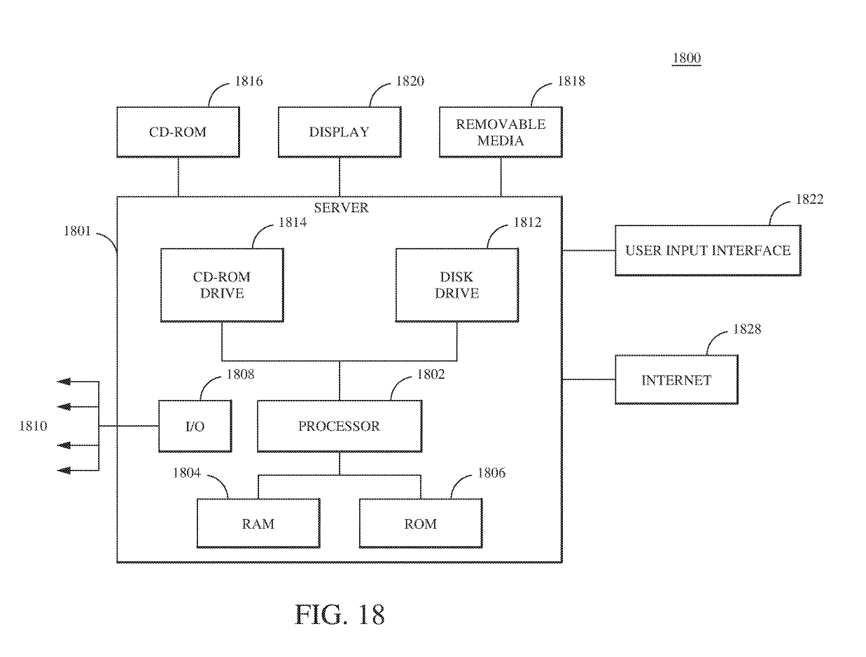

Seismic data generated by the seismic sources discussed above and acquired with the streamers also noted above may be processed in a corresponding processing device for generating a final image of the surveyed subsurface as discussed now with regard to FIG. 17. For example, the seismic data generated with the source elements as discussed with regard to FIGS. 6, 14A and 15A may be received in step 1700 at the processing device. In step 1702, pre-processing methods are applied, e.g., demultiple, signature deconvolution, trace summing, motion correction, vibroseis correlation, resampling, etc. In step 1704, the main processing takes place, e.g., deconvolution, amplitude analysis, statics determination, common middle point gathering, velocity analysis, normal move-out correction, muting, trace equalization, stacking, noise rejection, amplitude equalization, etc. In step 1706, final or post-processing methods are applied, e.g., migration, wavelet processing, seismic attribute estimation, inversion, etc.; in step 1708 the final image of the subsurface is generated.

An example of a representative vibrator controller capable of carrying out operations in accordance with the embodiments discussed above is illustrated in FIG. 18. Such a processing device may be any of the controllers discussed in the previous embodiments. Hardware, firmware, software or a combination thereof may be used to perform the various steps and operations described herein.

The exemplary processing device 1800 suitable for performing the activities described in the exemplary embodiments may include server 1801. Such a server 1801 may include a central processor unit (CPU) 1802 coupled to a random access memory (RAM) 1804 and/or to a read-only memory (ROM) 1806. The ROM 1806 may also be other types of storage media to store programs, such as programmable ROM (PROM), erasable PROM (EPROM), etc. Processor 1802 may communicate with other internal and external components through input/output (I/O) circuitry 1808 and bussing 1810 to provide control signals and the like. For example, processor 1802 may communicate with the various elements of the source element. Processor 1802 carries out a variety of functions as are known in the art, as dictated by software and/or firmware instructions.

Server 1801 may also include one or more data storage devices, including disk drives 1812, CD-ROM drives 1814, and other hardware capable of reading and/or storing information, such as a DVD, etc. In one embodiment, software for carrying out the above-discussed steps may be stored and distributed on a CD-ROM 1816, removable media 1818 or other form of media capable of storing information. The storage media may be inserted into, and read by, devices such as the CD-ROM drive 1814, disk drive 1812, etc. Server 1801 may be coupled to a display 1820, which may be any type of known display or presentation screen, such as LCD, plasma displays, cathode ray tubes (CRT), etc. A user input interface 1822 is provided, including one or more user interface mechanisms such as a mouse, keyboard, microphone, touch pad, touch screen, voice-recognition system, etc.

Server 1801 may be coupled to other computing devices, such as the equipment of a vessel, via a network. The server may be part of a larger network configuration as in a global area network (GAN) such as the Internet 1828, which allows ultimate connection to various landline and/or mobile client/watcher devices.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer-readable medium may be utilized, including hard disks, CD-ROMs, digital versatile discs (DVD), optical storage devices or magnetic storage devices such a floppy disk or magnetic tape. Other non-limiting examples of computer-readable media include flash-type memories or other known types of memories.

This written description uses examples of the subject matter disclosed to enable any person skilled in the art to practice the same, including making and using any devices or systems and performing any incorporated methods. For greater clarity, the figures used to help describe the invention are simplified to illustrate key features. For example, figures are not to scale and certain elements may be disproportionate in size and/or location. Furthermore, it is anticipated that the shape of various components may be different when reduced to practice, for example, to improve their properties. One or more of the elements shown in the above embodiments can be incorporated into any embodiment to further improve the overall performance and/or function of the invention. The patentable scope of the subject matter is defined by the claims, and may include other examples that occur to those skilled in the art. Such other examples are intended to be within the scope of the claims. Those skilled in the art would appreciate that features from any embodiments may be combined to generate a new embodiment.

The disclosed embodiments provide a method and source element capable attenuating pressure imbalances without a great demand of compressed air. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A source element for generating seismic waves in water, the source element comprising:
a housing having an opening;
an acoustic piston closing the opening;
an actuating mechanism located inside the housing and configured to actuate the acoustic piston; and
a decoupling mechanism interposed between the acoustic piston and the actuating mechanism,
wherein the decoupling mechanism allows the acoustic piston to move substantially independent of the actuating mechanism for a first frequency range.

2. The source element of claim 1, wherein the decoupling mechanism forces the acoustic piston to move in unison with the actuating mechanism for a second frequency range, different from the first frequency range.

3. The source element of claim 2, wherein the first frequency range includes low frequencies and the second frequency range includes high frequencies, the low and high frequencies being in a range of zero to 200 Hz.

4. The source element of claim 2, wherein the first frequency range is below 5 Hz and the high frequency range is above 10 Hz.

5. The source element of claim 2, wherein the first frequency range is below 5 Hz and the high frequency range is above 5 Hz.

6. The source element of claim 1, wherein the decoupling mechanism includes a dashpot.

7. The source element of claim 6, wherein the dashpot includes a viscous fluid for dampening a movement of the acoustic piston.

8. The source element of claim 6, wherein the dashpot includes an eddy current damper.

9. The source element of claim 6, wherein the actuating mechanism includes a moving magnet and the dashpot is located between two rods, one rod connected to the acoustic piston and the other rod connected to the moving magnet.

10. The source element of claim 6, wherein the dashpot has an outside path for allowing fluid from a first chamber of the dashpot to move to a second chamber of the dashpot.

11. The source element of claim 1, further comprising:
a flow control mechanism located on an outside path of the decoupling mechanism for adjusting a damping function of the decoupling mechanism.

12. The source element of claim 11, wherein the flow control mechanism is configured to adjust the decoupling mechanism to behave as a rigid element.

13. The source element of claim 1, wherein pressure imbalances between an ambient pressure and a pressure inside the housing are reduced by the decoupling mechanism by allowing the acoustic piston to oscillate relative to the actuating mechanism.

14. A method for generating seismic waves in water, the method comprising:
deploying to a certain depth in water a housing having an opening and an acoustic piston closing the opening;
actuating an actuating mechanism located inside the housing to move the acoustic piston to generate the seismic waves; and
allowing the acoustic piston to move substantially independent of the actuating mechanism for a first frequency range, by interposing a decoupling mechanism between the acoustic piston and the actuating mechanism.

15. The method of claim 14, wherein the decoupling mechanism forces the acoustic piston to move in unison with the actuating mechanism for a second frequency range, different from the first frequency range.

16. The method of claim 15, wherein the first frequency range includes low frequencies and the second frequency range includes high frequencies, the low and high frequencies being in a range of zero to 200 Hz.

17. The method of claim 14, wherein the decoupling mechanism includes a dashpot.

18. The method of claim 14, further comprising:
adjusting, with a flow control mechanism located on an outside path of the decoupling mechanism, a damping function of the decoupling mechanism.

19. A source element for generating seismic waves in water, the source element comprising:
an acoustic piston;
an actuating mechanism configured to actuate the acoustic piston; and
a decoupling mechanism interposed between the acoustic piston and the actuating mechanism,
wherein the decoupling mechanism allows the acoustic piston to move relative to a moving part of the actuating mechanism for a first frequency range.

20. The source element of claim 19, wherein the moving part is mechanically connected to the acoustic piston through the decoupling mechanism.
